(19) United States
(12) Patent Application Publication
(10) Pub. No.: US 2009/0049971 A1
(43) Pub. Date: Feb. 26, 2009

(54) Punch

(75) Inventors: Ayano Yamashita, Tokyo (JP); Naoki Ozawa, Tokyo (JP); Hiroyuki Urabe, Tokyo (JP); Emiko Osawa, Tokyo (JP)

Correspondence Address: OLIFF & BERRIDGE, PLC, P.O. BOX 320850, ALEXANDRIA, VA, 22320-4850, US

(73) Assignee: CARL MANUFACTURING CO., LTD., Tokyo (JP)

(21) Appl. No.: 12/216,984

(22) Filed: Jul. 14, 2008

(30) Foreign Application Priority Data
Aug. 20, 2007 (JP) 2007-214133

(51) Int. Cl. B26F 1/04; B26F 1/14

(52) U.S. Cl. 83/468; 83/618; 83/633; 83/686

(57) ABSTRACT

A punch for forming a die-cut pattern in a sheet inserted into a slit includes a punch cutter and a base having a wall portion with which the sheet comes in contact, the wall portion being constituted of a rear wall portion extending from a frontal center portion to one side of the punch and an inclined wall portion extending rearward to the other side at of the punch an angle of 45 degrees with respect to a line extending from the rear wall portion. In the slit, a first positioning member having a ruler portion extending to one side and a second positioning member having a ruler portion extending to the other side are installed so that the ruler portions are each turnable around the punch cutter positioned therebetween.

### BACKGROUND OF THE INVENTION

1. Field of the Invention

The present invention relates to a punch for forming a specified die-cut pattern in a sheet such as a paper, cloth, or the like, more particularly to a punch with which die-cut patterns having different directions can be readily formed.

2. Description of the Related Art

A craft punch is constructed such that a punch cutter having a cutting edge directed downward is mounted in a base in a state in which it is subjected to a lifting force, the base including a guideway, with which the punch cutter is guided to slide along a surface of the guideway, and a slit orthogonal to the guideway; the punch cutter, when depressed, works in combination with a corner portion, where the guideway and slit cross each other, to form a specifically shaped die-cut pattern in a sheet, as disclosed in Japanese Unexamined Patent Application Publication No. 2006-255877.

In such a punch, it is possible to position a sheet by inserting into the slit and allowing an edge of the sheet to contact a rear wall of the slit so that a die-cut pattern spaced apart from the edge of the sheet can be formed at a predetermined position. In Japanese Registered Design No. 1039915, a punch is also disclosed which is provided with a positioning member for positioning a sheet so that a specifically shaped die-cut pattern is formed in a corner portion of the sheet.

In the case of a punch disclosed in Japanese Registered Design No. 1039915, however, it is not possible to position a sheet except when a die-cut pattern is formed in a corner portion of the sheet.

Additionally, any of these punches allows only a single die-cut pattern to be formed, and particularly in the case when a die-cut pattern is continuously formed using a punch disclosed in Japanese Unexamined Patent Application Publication No. 2006-255877, die-cut patterns directed to the same direction are merely continuously formed, which causes that a variety of creative works cannot be widened.

### SUMMARY OF THE INVENTION

An object of the present invention is to provide a punch with which specified die-cut patterns having different directions can be formed in a sheet.

According to a first aspect of the invention, a punch for forming a specifically shaped die-cut pattern in a sheet is constructed from a punch cutter, having a cutting edge directed downward, which forms the die-cut pattern in the sheet by being depressed, and a base in which the punch cutter is mounted in a state in which it is subjected to a lifting force, the base including a guideway with which the punch cutter is guided to slide along a surface of the guideway, and a slit orthogonal to the guideway, into which the sheet is to be inserted; wherein a wall portion with which the sheet comes in contact is constituted of a rear wall portion, which extends from a frontal center portion to one side of the punch, and an inclined wall portion, which extends rearward to the other side of the punch at an angle of 45 degrees with respect to a line extending from the rear wall portion. It is therefore possible to form different die-cut patterns by allowing the sheet to contact the rear wall portion or to the inclined wall portion when the sheet is positioned. As a result, various die-cut patterns can be formed and a variety of creative works can be widened.

According to a second aspect of the invention, the punch is further provided in the slit with a first positioning member having a ruler portion extending frontward on one side portion at an angle of 45 degrees with respect to the rear wall portion when located in its initial position, and a second positioning member having a ruler portion extending frontward on the other side portion at an angle of 45 degrees with respect to the rear wall portion when located in its initial position so that the ruler portions are each turnable around the punch cutter positioned therebetween; thereby it is possible to position a sheet having any corner angle by turning the positioning members so as to fit to the corner of the sheet.

Moreover, it is possible to position a sheet more accurately by allowing an edge of the sheet to contact the ruler portions of the first and second positioning members when the sheet inserted into the slit is in contact with the rear wall portion or inclined wall portion.

According to a third aspect of the invention, each of the first and second positioning members is provided with a plane portion on which a sheet is to be placed; thereby the sheet can be placed in a stable state.

Furthermore, the plane portion is provided with a ring portion mounted around a pipe portion surrounding a punching region of the punch cutter. Due to the simple and compact structure of the first and second positioning members, each of the plane portions thereof can be easily turned in a state that the ruler portions are located across from each other with respect to the punch cutter.

According to a fourth aspect of the invention, the first and second positioning members are configured such that, when their plane portions are in contact with each other at their edge portions, their ruler portions make an angle of 90 degrees with each other. It is therefore possible to position a rectangular shaped sheet, when a die-cut pattern is formed in its corner portion, by allowing the respective plane portions to contact each other at their edge portions.

According to a fifth aspect of the invention, each of the first and second positioning members is provided with a stopper for maintaining the member at a position where a sheet comes in contact with the ruler portion when the sheet is in contact with the rear wall portion of the slit. The first and second positioning members in a state of being positioned there are therefore not to be turned easily.

### BRIEF DESCRIPTION OF THE DRAWINGS

FIG. 1 is a perspective view of a punch according to an embodiment of the present invention;

FIG. 2 is a vertical cross-section view of the punch;

FIG. 3 shows examples of die-cut patterns of punch cutters of the punch;

FIG. 4 is a cross-section view of the punch cut at its slit portion;

FIG. 5 is a plan view of the lower housing of the punch;

FIG. 6 shows plan views of the first and second positioning members of the punch;

FIG. 7A shows the first and second positioning members, which are turnably mounted in the punch, in a state when they are in the initial position, FIG. 7B shows them when a sheet comes in contact with the rear wall portion, and FIG. 7C shows them when a sheet comes in contact with the inclined wall portion; and

FIG. 8A shows an example of a die-cut pattern formed in a corner portion using the positioning members in the state shown in FIG. 7A, FIG. 8B shows die-cut patterns formed in an edge portion using the positioning members in the state shown in FIG. 7B, and FIG. 8C shows die-cut patterns formed using the positioning members in the state shown in FIG. 7C.

### DESCRIPTION OF THE PREFERRED EMBODIMENTS

A preferable embodiment of the present invention will be described below with reference to the attached drawings. It should be understood that the present invention is not limited to the embodiment described below, and other embodiments can be devised which will solve the problem to be solved by the present invention.

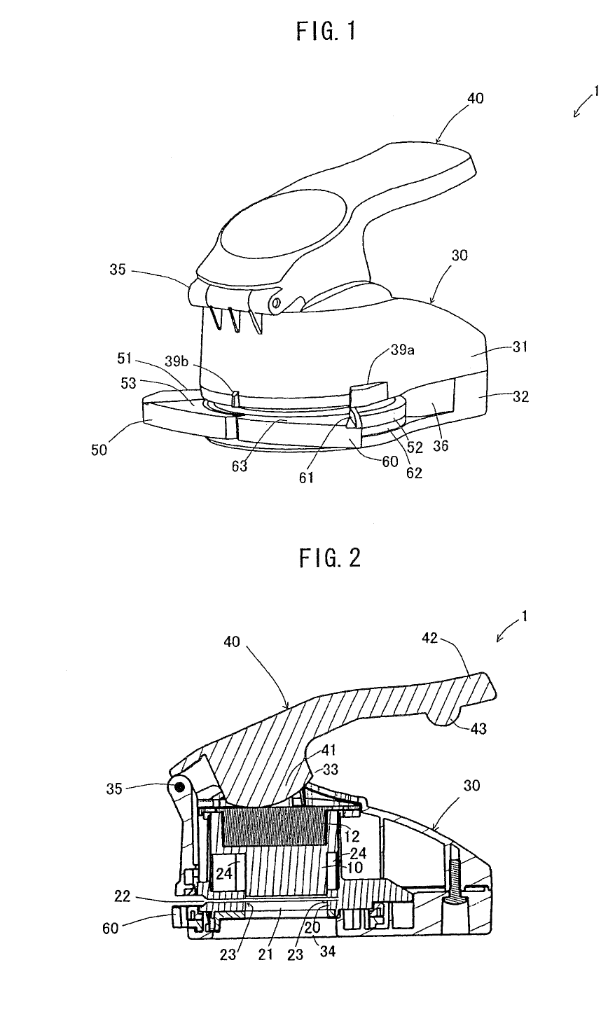

FIG. 1 is a perspective view of punch 1 according to an embodiment of the present invention.

The punch 1 of the present invention is a die-cut punch for forming a prescribed die-cut pattern in a sheet such as a paper, cloth, cellophane, leather or the like, and is constructed from punch cutter 10, punch base 20, housing 30 accommodating an assembly of these members, handle 40 pivotally supported by the housing 30, first positioning member 50 and second positioning member 60, as shown in FIG. 2.

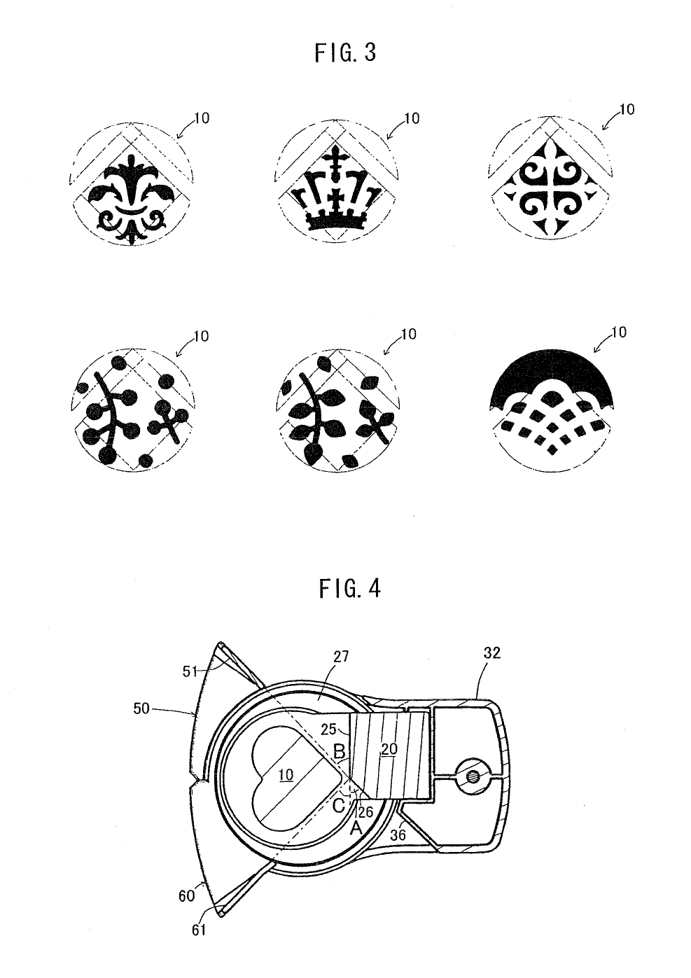

The punch cutter 10 has a predetermined cross-sectional shape such as a circle, triangle, square, star or other figures, a numeral, symbol, alphabet or other characters, a pattern constituted of a group of figures shown in FIG. 3, or the like, and is provided on its lower end portion with a cutting edge, which works in combination with the punch base 20 to punch holes in a sheet.

On the top end of the punch cutter 10, there is provided pressing portion 12 with which the handle 40 is in contact. The punch cutter 10 is inserted in guideway 21 of the punch base 20 in a state that the cutting edge is directed downward.

The punch base 20 is made of a metal such as lead or the like, and includes the guideway 21, with which the punch cutter 10 is guided to slide along a surface of the guideway, and slit 22 orthogonal to the guideway. The punching is performed by depressing the punch cutter 10 onto a sheet having been inserted into the slit 22; the punch cutter 10 works in combination with a corner portion (i.e., a portion that functions as a lower cutter), where the slit 22 and guideway 21 cross each other, to punch holes in the sheet.

As shown in FIG. 4, the punch base 20 is provided in the rear end of the slit 22 with rear wall portion 25 extending from a frontal center portion to one side of the punch 1, and inclined wall portion 26 extending rearward to the other side of the punch 1 at angle “A” of 45 degrees with respect to a line extending from the rear wall portion 25.

A position spaced apart from an edge of a sheet, where a die-cut pattern is to be formed, can be set by inserting the sheet into the slit 22 and by allowing it to contact the rear wall portion 25 or inclined wall portion 26.

The punch base 20 is provided with flange portion 27 in its lower end, the flange portion 27 having an outside diameter corresponding to ring portions 52, 62 of positioning members 50, 60 described later. Moreover, the flange portion 27 is provided with a joint portion (not shown) joined to lower housing 32 described later.

Between the punch cutter 10 and punch base 20, spring 24 is provided, as shown in FIG. 2, due to which the punch cutter 10 is integrated into the housing 30 in a state in which it is subjected to a lifting force.

The housing 30 is constructed by joining upper housing 31 and lower housing 32 using a screw or the like, the upper housing 31 being provided with opening portion 33 where the pressing portion 12 of the punch cutter 10 is exposed, and the lower housing 32 being provided with opening portion 34 for discharging a punched piece of sheet.

On the rear side of the lower housing 32, there is formed contact wall 36, with which the second positioning member 60 described later comes into contact, at a position extended from the inclined wall portion 26 of the punch base 20 (see FIG. 4).

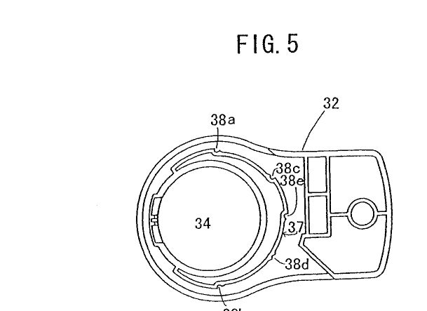

Around the opening portion 34 of the lower housing 32, pipe portion 37 is formed that has an outside diameter corresponding to that of the flange portion 27 of the punch base 20 as shown in FIG. 5. The pipe portion 37 serves to mount the first and second positioning members 50, 60 so as to be turnable, and is provided with a sliding way on its outer periphery surface, the sliding way enabling lug portions 54, 64 provided inside ring portions 52, 62 of the positioning members 50, 60, respectively, to move in a state when the ring portions 52, 62 are mounted on the pipe portion 37. The sliding way has uneven spots on its surface, corresponding to turning ranges of the positioning members 50, 60, and is provided with indented portions 38a, 38b, 38c, 38d, 38e at predetermined locations.

The upper housing 31 is provided with mark 39a for indicating where the inclined wall portion 26 is situated, and mark 39b for indicating the frontal center portion.

The upper housing 31 and lower housing 32 are coupled at the position of the slit 22 of the punch base 20 in a state having the positioning members 50, 60 therebetween, and at pivot portion 35 provided in an upper part of the coupled housings, one end portion of the handle 40 is pivotably mounted.

On an undersurface of the one end portion of the handle 40, convex-shaped portion 41 is formed that serves to press down the pressing portion 12 of the punch cutter 10 through the opening portion 33 of the upper housing 31 (see FIG. 2). In the other portion of the handle 40 handle actuating portion 42 is formed, and on its undersurface stopping portion 43 for restricting a pressed-down amount is formed.

Next, the first and second positioning members 50, 60 disposed between the upper housing 31 and lower housing 32 will be described below.

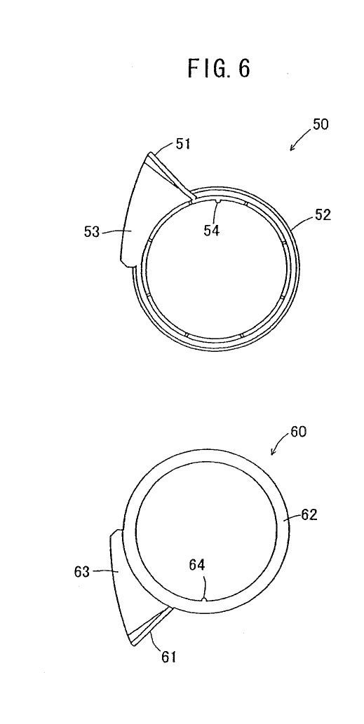

The first and second positioning members 50, 60 are a pair of substantially symmetrically shaped members, as shown in FIG. 6, and serve to position a sheet by allowing its corner and/or edge to contact their wall portions.

The first positioning member 50 for supporting an edge of the sheet on one side (i.e., the edge on the side of the rear wall portion 25 of the punch 1) is composed of ring portion 52 and plane portion 53, and is provided with ruler portion 51 for being in contact with the edge of the sheet at one end of the plane portion 53 in a standing state. The ring portion 52 is provided with an opening having an inner diameter corresponding to that of the pipe portion 37 of the lower housing 32, and the lug portion 54 is formed inside the opening.

Likewise, the second positioning member 60 for supporting the other edge of the sheet (i.e., the edge on the side of the inclined wall portion 26 of the punch 1) is composed of ring portion 62 and plane portion 63, and is provided with ruler portion 61 at an end of the plane portion 63 on the side opposite to that of the first positioning member 50. The lug portion 64 is formed inside an opening provided in the ring portion 62.

That is, the ruler portion 51 of the first positioning member 50 extends frontward on the one side portion at angle “B” of 45 degrees with respect to the rear wall portion 25, and the ruler portion 61 of the second positioning member 60 extends frontward on the other side portion at angle “C” of 45 degrees, when situated in the initial position shown in FIGS. 1 and 4.

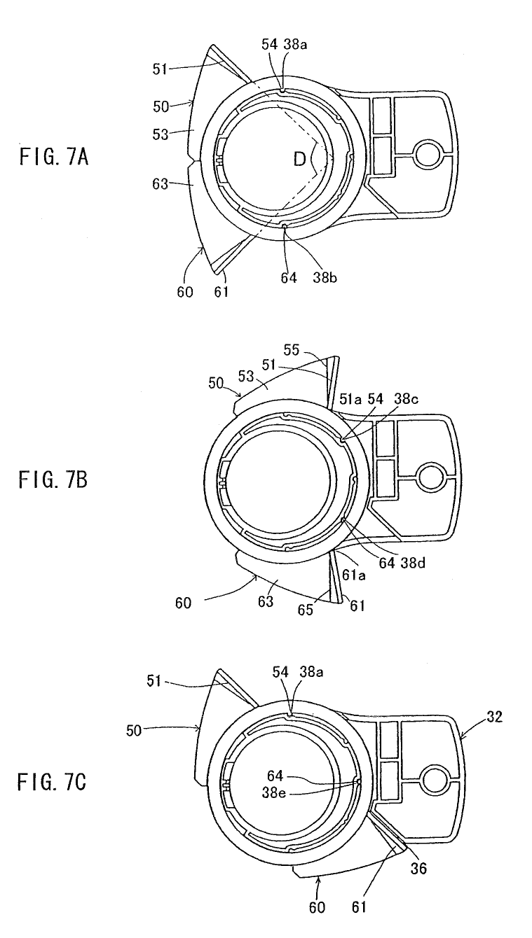

These positioning members 50, 60 are designed such that, when mounted in sequence around the pipe portion 37 of the lower housing 32 and allowed to contact each other at their edge portions, their plane portions 53, 63 become flush with each other and their ruler portions 51, 61 make angle “D” of 90 degrees with each other (see FIG. 7A).

Because of the configuration described above, in a state when the first and second positioning members 50, 60 are mounted to the pipe portion 37 of the lower housing 32, the ruler portions 51, 61 can be each turned around the punch cutter 10 positioned therebetween.

In the next place, a method for forming a die-cut pattern in a sheet using a punch configured as described above will be described below.

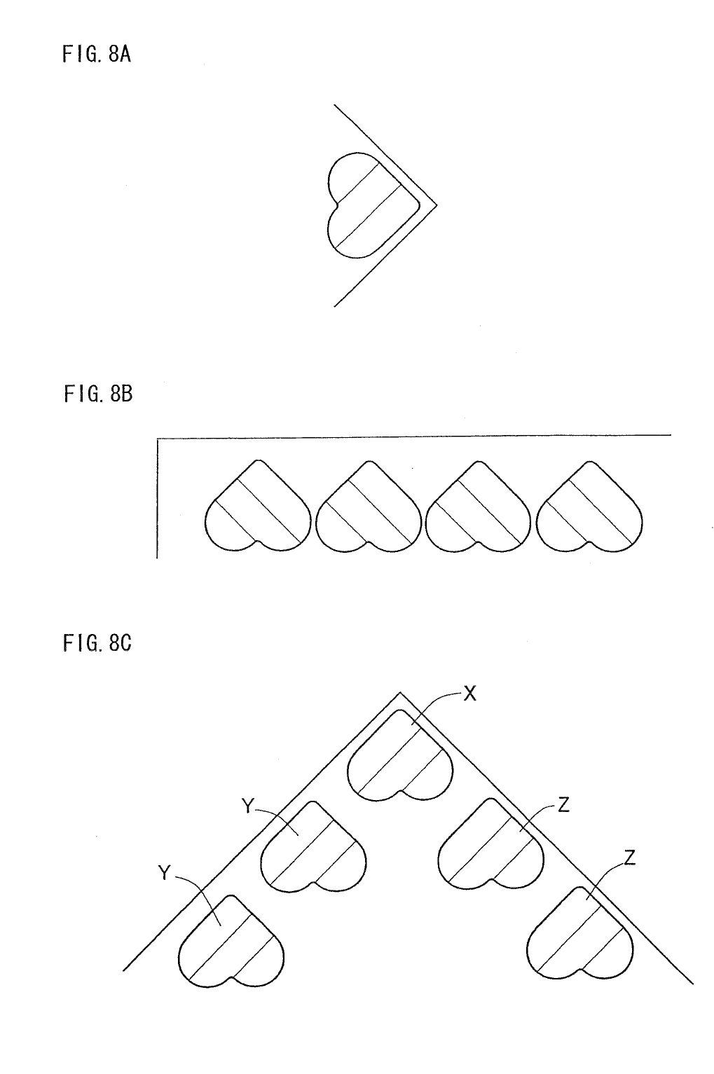

In the case of forming a die-cut pattern in a corner portion of a sheet as shown in FIG. 8A, the positioning members 50, 60 are turned to be set in a state shown in FIG. 7A. In this occasion, the lug portion 54 of the first positioning member 50 fits in the indented portion 38a and the lug portion 64 of the second positioning member 60 fits in the indented portion 38b; thereby the position of each of the positioning members 50, 60 is fixed.

A sheet is placed on the plane portions 53, 63 of the positioning members 50, 60 in this state, and edges of the sheet adjacent to one of its corners are allowed to contact the ruler portions 51, 61, respectively; then punching operation is performed.

In the case of forming die-cut patterns along an edge of a sheet shown in FIG. 8B, the positioning members 50, 60 are set in a state shown in FIG. 7B. Then, the lug portion 54 fits in the indented portion 38c and the lug portion 64 fits in the indented portion 38d, and base ends 51a, 61a of the ruler portions 51, 61 are each positioned on a line extending from the rear wall portion 25 of the punch base 20. Due to this arrangement, the sheet can be supported in a state that the edge of the sheet is laid along the rear wall portion 25 of the punch base 20, and thereby the die-cut patterns shown in FIG. 8B can be formed. It is noted that it is also possible to check the parallelity between the edge of the sheet and the rear wall portion 25 by fitting the edge of the sheet to stepped portions 55, 65 provided on the plane portions 53, 63.

In the case of forming die-cut patterns along edges of a sheet shown in FIG. 8C, die-cut pattern “X” is first formed with the positioning members 50, 60 set in the state shown in FIG. 7A, and then the positioning members 50, 60 are set in the state shown in FIG. 7C. Then, the ruler portion 61 of the second positioning member 60 is in contact with the contact wall 36 of the lower housing 32, and the lug portion 64 of the second positioning member 60 fits in the indented portion 38e. Die-cut patterns “Y” are formed in one edge portion of the sheet by punching in this state, and then the sheet is turned inside out to form die-cut patterns “Z” in the other edge portion of the sheet.

As described above, since the mounting of the first and second positioning members 50, 60 onto the pipe portion 37 of the lower housing 32 enables each of the ruler portions 51, 61 to turn around the punch cutter 10 positioned therebetween, it becomes possible to position a corner of a sheet in place and to form die-cut patterns oriented in various directions at respective precise positions.

It should be noted that, in the present invention, the positioning members 50, 60 are not necessarily required. At that time, positioning may be carried out by allowing an edge of a sheet to contact the rear wall portion 25 or inclined wall portion 26 of the punch base 20.

It should also be noted that the first and second positioning members 50, 60 of the present invention are not necessarily required to be provided with the plane portions 53, 63, because positioning may be carried out only with at least the ruler portions 51, 61.

Likewise, the lug portions 54, 64 and the indented portions 38, which serve as stoppers for fixing the first and second positioning members 50, 60, are not necessarily required to be provided. It may be possible to provide a stopper each time depending on predetermined angles or to install stoppers at various locations.

The present invention can be applied to a punch that is used not only in the field of craftwork and handcraft, but also in the field of office work and/or industry.

1. A punching for forming a specifically shaped die-cut pattern in a sheet, comprising:
a punch cutter, having a cutting edge directed downward, which forms the die-cut pattern in the sheet by being depressed; and
a base in which the punch cutter is mounted in a state in which it is subjected to a lifting force, the base including a guideway with which the punch cutter is guided to slide along a surface of the guideway, and a slit orthogonal to the guideway, into which the sheet is to be inserted,
wherein a wall portion with which the sheet comes in contact is constituted of a rear wall portion, which extends from a frontal center portion to one side of the punch, and an inclined wall portion, which extends rearward to the other side of the punch at an angle of 45 degrees with respect to a line extending from the rear wall portion.

2. The punch according to claim 1, further comprising:
a first positioning member having a ruler portion extending frontward on one side portion of the punch at an angle of 45 degrees with respect to the rear wall portion when located in its initial position; and
a second positioning member having a ruler portion extending frontward on the other side portion of the punch at an angle of 45 degrees with respect to the rear wall portion when located in its initial position,
wherein the first and second positioning members are installed in the slit so that the ruler portions are each turnable around the punch cutter positioned therebetween.

3. The punch according to claim 2,
wherein each of the first and second positioning members is composed of a plane portion on which a sheet is to be placed and the ruler portion standing up from the plane portion, and a ring portion attached to the plane portion, the ring portion being mounted around a pipe portion surrounding a punching region of the punch cutter.

4. The punch according to claim 3,
wherein the first and second positioning members are configured such that, when their plane portions are in contact with each other at their edge portions, their ruler portions make an angle of 90 degrees with each other.

5. The punch according to claim 2,
wherein each of the first and second positioning members is provided with a stopper for maintaining the member at a position where a sheet comes in contact with the ruler portion when the sheet is in contact with the rear wall portion of the slit.

6. The punch according to claim 3,
wherein each of the first and second positioning members is provided with a stopper for maintaining the member at a position where a sheet comes in contact with the ruler portion when the sheet is in contact with the rear wall portion of the slit.

7. The punch according to claim 4,
wherein each of the first and second positioning members is provided with a stopper for maintaining the member at a position where a sheet comes in contact with the ruler portion when the sheet is in contact with the rear wall portion of the slit.
